(19) United States
(12) Patent Application Publication
(10) Pub. No.: US 2020/0391672 A1
(43) Pub. Date: Dec. 17, 2020

(54) ELECTROMAGNETIC WAVE UTILIZATION SYSTEM FOR VEHICLE

(71) Applicant: DENSO CORPORATION, Kariya-city (JP)

(72) Inventors: Kotaro FUKUDA, Kariya-city (JP); Koji OTA, Kariya-city (JP); Naoki YOKOYAMA, Kariya-city (JP); Junji GOTO, Kariya-city (JP); Tatsuhiko NISHINO, Kariya-city (JP)

(21) Appl. No.: 17/004,976

(22) Filed: Aug. 27, 2020

Related U.S. Application Data
(63) Continuation of application No. PCT/JP2019/000182, filed on Jan. 8, 2019.

(30) Foreign Application Priority Data
Mar. 7, 2018 (JP) 2018-040705

(51) Int. Cl. B60R 11/04; B60J 1/02; B60J 1/20

(52) U.S. Cl. CPC B60R 11/04; B60R 2011/0026; B60J 1/2094; B60J 1/02

(57) ABSTRACT

An electromagnetic wave utilization system for a vehicle includes an electromagnetic wave device that sends or/and receives an electromagnetic wave, and a passage part through which passes the electromagnetic wave utilized by the electromagnetic wave device. The passage part has a hydrophilic portion having hydrophilicity. Accordingly, it is possible to suppress fogging of the passage part through which the electromagnetic wave passes with a simple configuration.

### CROSS REFERENCE TO RELATED APPLICATION

The present application is a continuation application of International Patent Application No. PCT/JP2019/000182 filed on Jan. 8, 2019, which designated the U.S. and claims the benefit of priority from Japanese Patent Application No. 2018-40705 filed on Mar. 7, 2018. The entire disclosures of all of the above applications are incorporated herein by reference.

### TECHNICAL FIELD

The present disclosure relates to an electromagnetic wave utilization system that uses electromagnetic waves for a vehicle.

### BACKGROUND

An in-vehicle camera captures an image of a rear view of a vehicle. The in-vehicle camera is installed on the ceiling in the vehicle cabin in proximity to the rear window, and captures an image of the outside through the rear window.

### SUMMARY

In one aspect of the present disclosure, an electromagnetic wave utilization system for a vehicle includes:

an electromagnetic wave device configured to send and/or receive an electromagnetic wave; and

a passage part through which passes the electromagnetic wave utilized by the electromagnetic wave device.

The passage part has a hydrophilic portion having hydrophilicity.

### BRIEF DESCRIPTION OF DRAWINGS

FIG. 1 is a cross-sectional view illustrating a vehicle equipped with an imaging device according to a first embodiment.

FIG. 2 is a partially enlarged cross-sectional view illustrating the imaging device of FIG. 1.

FIG. 3 is a cross-sectional view illustrating a laser device according to a second embodiment.

FIG. 4 is a view as viewed from an arrow direction IV in FIG. 3.

### DETAILED DESCRIPTION

To begin with, examples of relevant techniques will be described.

An in-vehicle camera captures an image of a rear view of a vehicle. The in-vehicle camera is installed on the ceiling in the vehicle cabin in proximity to the rear window, and captures an image of the outside through the rear window.

In this art, the in-vehicle camera is installed so that a heater wire of the defogger on the rear window is not included in the imaging range of the camera. The defogger is a device that clears fog on the rear window by heating the rear window with the heater wire.

According to this art, since the in-vehicle camera is installed so that the heater wire of the defogger in the rear window does not enter the imaging range, the view area of the in-vehicle camera is not obstructed by the heater wire of the defogger.

However, according to this art, since there is no heater wire of the defogger in the imaging range, the fogging in the imaging range cannot be effectively cleared. Therefore, under the condition that fogging is generated on the rear window, there is a possibility that the visibility and the view area of the in-vehicle camera may not be sufficiently secured.

Further, since it is necessary to control the power supplied to the heater wire, the configuration is complicated.

This issue occurs not only in the in-vehicle camera that captures visible light, but also in various vehicle electromagnetic wave utilization systems that use electromagnetic waves, such as a laser device that transmits and receives laser light for a vehicle.

The present disclosure provides an electromagnetic wave utilization system for a vehicle, to suppress fogging of a passage part through which an electromagnetic wave passes with a simple configuration.

In one aspect of the present disclosure, an electromagnetic wave utilization system for a vehicle includes:

an electromagnetic wave device configured to send and/or receive an electromagnetic wave; and

a passage part through which passes the electromagnetic wave utilized by the electromagnetic wave device.

The passage part has a hydrophilic portion having hydrophilicity.

Accordingly, it is possible to suppress the fogging of the passage part through which the electromagnetic wave passes with a simple configuration.

Hereinafter, embodiments will be described with reference to the drawings. In the following embodiments, identical or equivalent elements are denoted by the same reference numerals as each other in the drawings.

### First Embodiment

Hereinafter, an imaging device for a vehicle according to the present embodiment will be described with reference to the drawings. In the drawings, the up, down, front and rear arrows indicate the up, down, front and rear directions of the vehicle. The imaging device corresponds to a vehicular electromagnetic wave utilization system that uses visible light, which is a type of electromagnetic waves.

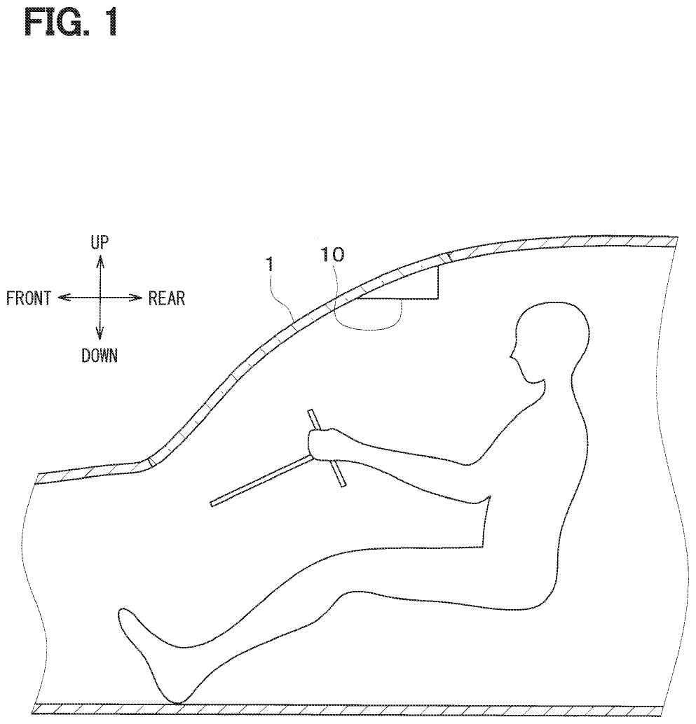

As shown in FIG. 1, a camera unit 10 is mounted on an inner surface of the windshield 1 of the vehicle in the cabin. The camera unit 10 is attached to the upper portion of the windshield 1 and is located at a substantially central portion in the left-right direction. The camera unit 10 is located near a rear-view mirror (not shown).

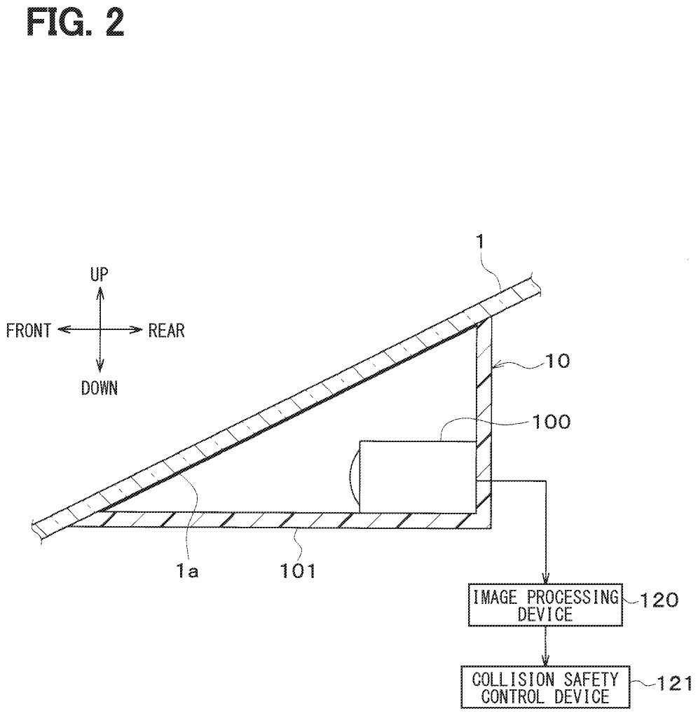

As shown in FIG. 2, the camera unit 10 has a camera 100 and a housing 101. The camera 100 captures an image of the outside in front of the vehicle through a window (the windshield 1 in this embodiment) of the vehicle. The camera 100 is an electromagnetic wave device that captures visible light, which is a type of electromagnetic waves. The windshield 1 is a passage part through which the visible light captured by the camera 100 passes.

The image data captured by the camera 100 is input to an image processing device 120. The image processing device 120 detects an object in front of the vehicle by processing the image data of the camera 100. The detection result of the image processing device 120 is output to a collision safety control device 121. The collision safety control device 121 controls, for example, a brake of the vehicle based on the detection result of the image processing device 120 to prevent a collision of the vehicle.

The camera 100 is housed in the housing 101. The housing 101 is a member that forms an outer shell of the camera unit 10. The housing 101 may be in close contact with the windshield 1, or a predetermined gap may be provided between the housing 101 and the windshield 1.

The windshield 1 has a hydrophilic portion 1a. For convenience of illustration, in FIG. 2, the hydrophilic portion 1a is indicated by a thick solid line.

The hydrophilic portion 1a is formed within an area of the inner surface of the windshield 1 in the cabin, and the area is surrounded by the housing 101. In other words, the hydrophilic portion 1a is formed at a portion of the inner surface of the windshield 1, through which visible light captured by the camera 100 passes. The hydrophilic portion 1a is formed by subjecting the windshield 1 to a hydrophilic treatment.

The hydrophilic treatment is, for example, a treatment for applying a polymer to the surface of the windshield 1 or a treatment for forming a fractal on the surface of the windshield 1.

When the hydrophilic portion 1a exhibits hydrophilicity, it is possible to restrict the windshield 1 from fogging even when the windshield 1 has dew condensation.

In other words, since the hydrophilic portion 1a exhibits hydrophilicity, even if the windshield 1 has dew condensation, fine water droplets that diffusely reflect light are not generated, so that the windshield 1 can be restricted from fogging.

Since the hydrophilic treatment of the hydrophilic portion 1a is physically weak and easily peeled off, the hydrophilicity cannot be maintained due to a situation such as touching by a human hand. According to the present embodiment, since the hydrophilic portion 1a is surrounded by the housing 101, the hydrophilic treatment can be protected from being touched by a human hand.

In the present embodiment, the windshield 1 has the hydrophilic portion 1a having hydrophilicity. Accordingly, it is possible to suppress the fogging on a portion of the windshield 1 through which the visible light captured by the camera 100 passes with a simple configuration.

In the present embodiment, the imaging device has the housing 101 that houses the camera 100, and the hydrophilic portion 1a is formed on the surface of the windshield 1 adjacent to the camera 100. Thereby, since the hydrophilic portion 1a can be protected from physical contact such as touching by a human hand, the hydrophilicity can be maintained.

### Second Embodiment

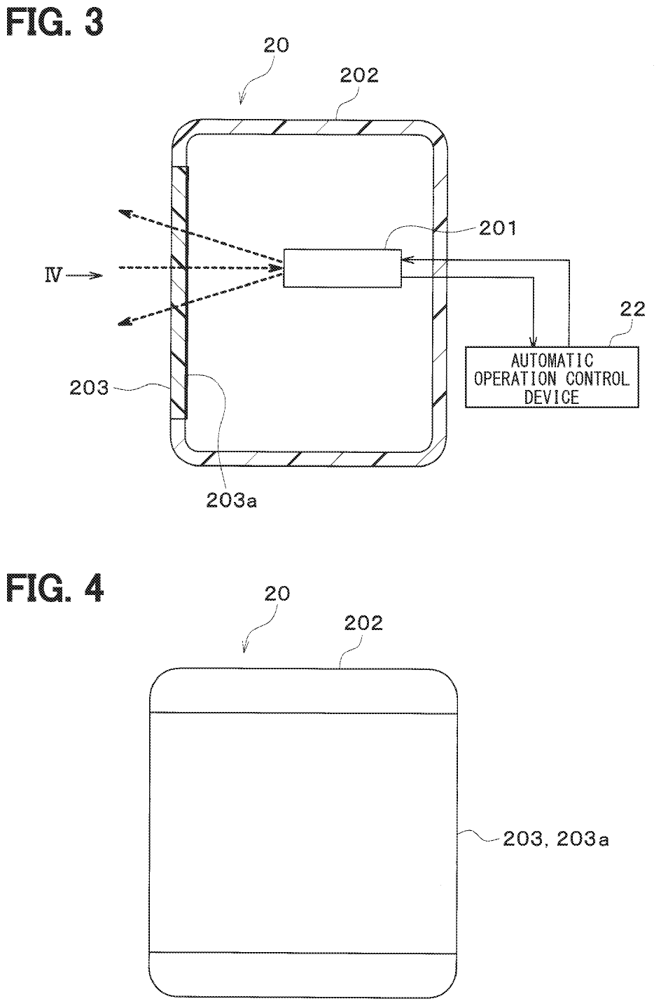

In the above-described embodiment, the imaging device for a vehicle includes the hydrophilic portion 1a. In the present embodiment, a laser device 20 for a vehicle includes a hydrophilic portion 203a, and will be described with reference to FIGS. 3 and 4.

The laser device 20 irradiates a pulse of laser light, which is a type of electromagnetic waves, and measures distance, direction, attributes, and the like of the target object based on a time period taken until the laser light is reflected by the object and returns back. The laser device 20 is used, for example, as a sensor for automatic driving of the vehicle.

The laser device 20 includes a laser transmitter 201, a housing 202, and a cover 203. The laser transmitter 201 is a device that irradiates a laser beam and detects an object and measures a distance to the object by receiving the laser beam reflected back from the object.

The laser device 20 is mounted on, for example, a bumper (not shown) of the vehicle. The laser device 20 irradiates the laser light frontward of the vehicle, and receives the laser light returned from the front of the vehicle. The laser light emitted by the laser device 20 is, for example, a laser light having a near-infrared wavelength.

The operation of the laser transmitter 201 is controlled by an automatic operation control device 22. The result of detection and the result of measurement by the laser transmitter 201 are input to the automatic operation control device 22. The automatic operation control device 22 performs automatic operation of the vehicle based on the detection result and the measurement result by the laser transmitter 201.

The laser transmitter 201 is housed in a tightly-closed space by the housing 202 and the cover 203. The housing 202 and the cover 203 are members that house the laser transmitter 201 and protect the laser transmitter 201. The housing 202 is arranged in an area through which laser light transmitted and received by the laser transmitter 201 does not pass. The cover 203 is arranged in a region through which the laser light transmitted and received by the laser transmitter 201 passes. The cover 203 is made of resin.

The cover 203 has the hydrophilic portion 203a. For convenience of illustration, in FIG. 3, the hydrophilic portion 203a is indicated by a thick solid line.

The hydrophilic portion 203a is formed on the inner surface of the cover 203. In other words, the hydrophilic portion 203a is formed at a portion of the inner surface of the cover 203 through which the laser beam transmitted and received by the laser transmitter 201 passes. The hydrophilic portion 203a is formed by subjecting the cover 203 to a hydrophilic treatment.

The hydrophilic treatment is, for example, a treatment for applying a polymer to the surface of the cover 203 or a treatment for forming a fractal on the surface of the cover 203.

When the hydrophilic portion 203a exhibits hydrophilicity, it is possible to restrict the cover 203 from fogging even when the cover 203 has dew condensation.

That is, since the hydrophilic portion 203a exhibits hydrophilicity, even if the cover 203 has dew condensation, fine water droplets that diffusely reflect light are not generated, so that the cover 203 can be restricted from fogging.

Since the hydrophilic treatment of the hydrophilic portion 203a is physically weak and easily peeled off, the hydrophilicity cannot be maintained due to a situation such as touching by a hand of the occupant. However, since the hydrophilic portion 203a is surrounded by the housing 202, the hydrophilic treatment can be protected from the hand of the occupant.

In the present embodiment, the cover 203 has the hydrophilic portion 203a having hydrophilicity. According to this, it is possible to suppress the fogging on a portion of the cover 203 through which the laser beam used by the laser transmitter 201 passes with a simple configuration.

In the present embodiment, the housing 202 is provided to house the laser transmitter 201, and the hydrophilic portion 203a is formed on the surface of the cover 203 facing the laser transmitter 201. Thereby, since the hydrophilic portion 203a can be protected from physical contact such as touching by a human hand, the hydrophilicity can be maintained.

### Other Embodiments

The above-described embodiments can be appropriately combined with each other. The above-described embodiments can be variously modified as follows, for example.

(1) In the first embodiment, the hydrophilic portion 1a is formed by performing a hydrophilic treatment on the inner surface of the windshield 1 in the vehicle cabin. Alternatively, the hydrophilic portion 1a is provided on the inner surface of the windshield 1 by stacking a hydrophilic member.

The hydrophilic member is a member having a hydrophilic surface. For example, the hydrophilic member is a film-like member having a predetermined thickness.

In the second embodiment, the hydrophilic portion 203a is formed by performing hydrophilic treatment on the surface of the cover 203 facing the laser transmitter 201. Alternatively, the hydrophilic portion 203a is formed on the surface of the cover 203 facing the laser transmitter 201 by stacking a hydrophilic member.

(2) In the first embodiment, the camera unit 10 is arranged on the windshield 1. Alternatively, the camera unit 10 may be arranged on a window other than the windshield 1, such as a rear glass.

(3) In the first embodiment, the image data of the camera 100 is used to restrict the collision of the vehicle. Alternatively, not limited to this, the image data of the camera 100 is used in various applications such as lane departure restriction and inter-vehicle distance measurement.

(4) The camera 100 according to the first embodiment is a camera that captures visible light, but may be a camera that captures infrared light or ultraviolet light.

(5) The laser device 20 of the second embodiment transmits and receives laser light relative to the front of the vehicle, but may transmit and receive laser light to directions other than the front of the vehicle.

For example, laser light may be transmitted and received while rotating the laser transmitter 201 in a horizontal plane. In that case, the housing 202 and the cover 203 may be rotated together with the laser transmitter 201, or the cover 203 may be provided so as to surround the laser transmitter 201 by 360 degrees.

(6) In the second embodiment, the hydrophilic portion 203a is formed on the cover 203 of the laser device 20, but a hydrophilic portion may be formed on a cover of a radio device for a vehicle. The radio device measures a distance, a direction, an attribute, and the like of a target object based on a time period from when a radio wave is emitted and to when the radio wave returns after reflected by an object. The radio device is used as, for example, a sensor for automatic driving of a vehicle.

In this case, the hydrophilic portion 203a restricts the cover of the radio device from fogging, not to affect the radio wave by moisture in the fogging.

(7) In the above embodiments, the imaging device and the laser device for a vehicle are described as specific examples of the electromagnetic wave utilization system. Alternatively, the electromagnetic wave utilization system may be a stationary imaging device, a stationary laser device, or the like.

What is claimed is:

1. An electromagnetic wave utilization system for a vehicle comprising:
an electromagnetic wave device configured to send or/and receive an electromagnetic wave while rotating in a horizontal plane; and
a passage part through which passes the electromagnetic wave utilized by the electromagnetic wave device, wherein
the passage part has a hydrophilic portion having hydrophilicity, and
the passage part and the hydrophilic portion are configured to rotate together with the electromagnetic wave device, or surround the electromagnetic wave device by 360 degrees in a horizontal direction.

2. The electromagnetic wave utilization system according to claim 1, further comprising:
a housing that houses the electromagnetic wave device, wherein
the hydrophilic portion is formed on a surface of the passage part facing the electromagnetic wave device.
